(19) United States
(12) Patent Application Publication
(10) Pub. No.: US 2015/0092944 A1
(43) Pub. Date: Apr. 2, 2015

(54) APPARATUS FOR CONTROLLING A SOUND SIGNAL

(71) Applicant: KABUSHIKI KAISHA TOSHIBA, Tokyo (JP)

(72) Inventors: Keiichiro SOMEDA, Kanagawa-ken (JP); Akihiko ENAMITO, Kanagawa-ken (JP)

(21) Appl. No.: 14/487,419

(22) Filed: Sep. 16, 2014

(30) Foreign Application Priority Data
Sep. 30, 2013 (JP) 2013-205871

(51) Int. Cl. H04S 7/00

(52) U.S. Cl. CPC H04S 7/302
USPC 381/1

(57) ABSTRACT

A first speaker radiates a first sound toward first and second listening points by a first sound signal. A second speaker radiates a second sound toward these points by a second sound signal. The first sound signal is generated by convolving a signal with a first filter coefficient. The second sound signal is generated by convolving the signal with a second filter coefficient. A nearer speaker to a virtual sound source is decided among the first and second speakers. The first and second filter coefficients are calculated so that a ratio of a first sound pressure of the first and second sounds at the first listening point to a second sound pressure thereof at the second listening point is equal to a target ratio. Among the first and second filter coefficients, based on one filter coefficient corresponding to the nearer speaker, the other filter coefficient corresponding to another speaker is calculated.

### CROSS-REFERENCE TO RELATED APPLICATION

This application is based upon and claims the benefit of priority from Japanese Patent Application No. 2013-205871, filed on Sep. 30, 2013; the entire contents of which are incorporated herein by reference.

### FIELD

Embodiments described herein relate generally to an apparatus for controlling a sound signal.

### BACKGROUND

As a method for imitating a sound effect of a stereophonic signal by front speakers, following conventional technique is known. In a sound control apparatus having this technique, control filter coefficients are calculated so that a sound pressure ratio of sounds transmitted from the front speakers at listener's both ears is equal to a target sound pressure ratio to realize the sound effect of the stereophonic signal. Thus, by using the control filter coefficients, sound control is performed. Here, the sound effect of the stereophonic signal is an effect for the listener to have an illusion as if the listener can listen to a sound from a virtual sound source.

As to this sound control apparatus, due to a position of the virtual sound source, values of the control filter coefficients used for sound control is often increased in surplus. As a result, a quality of the sound reproduced is deteriorated.

### BRIEF DESCRIPTION OF THE DRAWINGS

FIG. 1 is a schematic diagram to explain an outline of a sound control apparatus according respective embodiments.

FIG. 2 is a block diagram of the sound control apparatus according to the first embodiment.

FIGS. 3A and 3B are schematic diagrams showing relationship between a virtual sound source position and each speaker position according to the first embodiment.

FIG. 4 is a schematic diagram to explain a decision unit according to a modification of the first embodiment.

FIG. 5 is a block diagram of the sound control apparatus according to the second embodiment.

FIGS. 6A and 6B are schematic diagrams showing relationship between a virtual sound source position and each speaker position according to the second embodiment.

FIG. 7 is a schematic diagram showing relationship among each virtual sound source position, each speaker position, and a direction to which the listener faces according to the second embodiment.

FIG. 8 is a first example of frequency characteristic of output level of each speaker according to the second embodiment.

FIG. 9 is a second example of frequency characteristic of output level of each speaker according to the second embodiment.

FIG. 10 is a third example of frequency characteristic of output level of each speaker according to the second embodiment.

FIG. 11 is a fourth example of frequency characteristic of output level of each speaker according to the second embodiment.

### DETAILED DESCRIPTION

According to one embodiment, a sound control apparatus includes a first control filter, a second control filter, an input unit, a decision unit, and a calculator. The apparatus supplies a first sound signal to a first speaker and a second sound signal to a second speaker. The first speaker radiates a first sound toward a first listening point and a second listening point based on the first sound signal. The second speaker radiates a second sound toward the first listening point and the second listening point based on the second sound signal. The first control filter generates the first sound signal by convolving a sound signal with a first control filter coefficient. The second control filter generates the second sound signal by convolving the sound signal with a second control filter coefficient. The input unit inputs position information of a virtual sound source. The decision unit decides a nearer speaker to the virtual sound source among the first speaker and the second speaker, based on the position information. The calculator calculates the first control filter coefficient and the second control filter coefficient so that a ratio of a first synthesis sound pressure of the first sound and the second sound at the first listening point to a second synthesis sound pressure of the first sound and the second sound at the second listening point is equal to a target sound pressure ratio. Among the first control filter coefficient and the second control filter coefficient, one control filter coefficient corresponding to the nearer speaker is calculated. The other control filter coefficient corresponding to another speaker is calculated based on the one control filter coefficient.

Various embodiments will be described hereinafter with reference to the accompanying drawings.

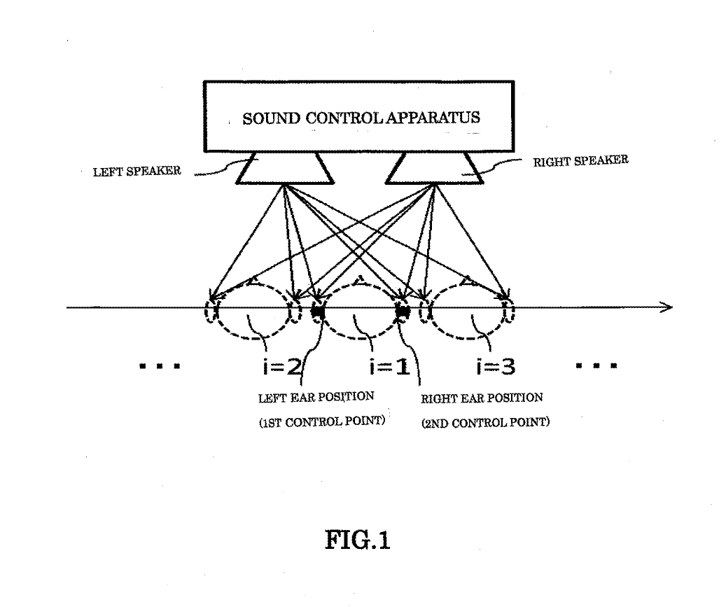

FIG. 1 is a schematic diagram to explain an outline of a sound control apparatus according respective embodiments. In the sound control apparatus explained hereinafter, for example, control filter processing is subjected to a monaural sound signal or a binaural sound signal, and front speakers (Hereinafter, it is called “speakers”) equipped with the sound control apparatus radiate sounds. A listener listens to the sounds (i.e., stereophonic sounds) from the speakers at a listening position (i) among one or a plurality of positions installed in front of the speakers. Here, the stereophonic sound is a sound imitating the monaural sound signal coming from a virtual sound source position, or the binaural sound signal.

If the sound source actually exists at the virtual sound source position, between sound signals arrived at the listener's both ears from the sound source, an amplifier ratio and a time difference (i.e., a phase difference) due to distance difference from the sound source to the listener's both (right and left) ears are assigned. Based on the amplifier ratio and the time difference, the listener can perceive a direction of the sound source.

As a basic control policy common to the respective embodiments, at each listening position (i), a complex sound pressure ratio (In case of a plurality of listening positions, a spatial average of the complex sound pressure ratio at a listening position set) at positions of the listener's both ears (a second listening point for the right ear to a first listening point for the left ear) is approximated (equal) to a complex sound pressure ratio (Alternatively, the complex sound pressure ratio of the binaural sound signal) (In case of a plurality of listening positions, a spatial average of the complex sound pressure ratio at the listening position set) of the sound signal arrived from the virtual sound source. Here, as a distance between the first listening point and the second listening point, for example, a distance between both ears of an average human can be used.

Based on above-mentioned control policy, in case of M units of front speakers, a control filter coefficient Wₘ(2≦m≦M) corresponding to the m-th speaker is calculated by following equations. Here, the control filter coefficient corresponding to the speaker is a coefficient of a control filter to output a sound signal to be reproduced from the speaker. Moreover, the control filter coefficient W₁ corresponding to the first speaker can be arbitrarily determined. In case of “W₁=1”, the first speaker has a through characteristic (output).

$$\begin{matrix}{W}_{m} = - {\sum }_{j = 1}^{m - 1} \frac{{B}_{j}^{( m )}}{{B}_{m}^{( m )}} {W}_{j} \\ ( 2 \leq m \leq M ) & ( 1 ) \\ {B}_{j}^{( m )} = {\sum }_{i = 1}^{N} {A}_{ij}^{( m )} \overline{{A}_{im}^{( m )}} \\ ( 1 \leq j \leq m ) & ( 2 ) \\ {A}_{ij}^{( m - 1 )} = {A}_{ij}^{( m )} - {A}_{im}^{( m )} \frac{{B}_{j}^{( m )}}{{B}_{m}^{( m )}} \\ ( 1 \leq i \leq N , 1 \leq j \leq m - 1 ) & ( 3 ) \\ {A}_{ij}^{( M )} = {C}_{{L}_{i} j} \cdot {d}_{{R}_{i}} - {C}_{{R}_{i} j} \cdot {d}_{{L}_{i}} \\ ( 1 \leq i \leq N , 1 \leq j \leq M ) & ( 4 )\end{matrix}$$

In above equations (1)˜(4), N is the number of listening positions to be considered, C_{Lij} is a head-related transfer function of the left ear from the j-th speaker to the i-th listening position, C_{Rij} is a head-related transfer function of the right ear from the j-th speaker to the i-th listening position, d_{Li} is a head-related transfer function of the left ear from the virtual sound source to the i-th listening position, and d_{Ri} is a head-related transfer function of the right ear from the virtual sound source to the i-th listening position.

Namely, as apparent from above equations, by setting the control filter coefficient W₁ corresponding to the first speaker (main speaker) to a reference control filter coefficient, the control filter coefficient Wₘ(2≦m≦M) corresponding to any of the subsequent speaker is calculated based on this control filter coefficient W₁. Furthermore, the control filter coefficient W_{M} corresponding to the M-th speaker is calculated based on all the other control filter coefficients Wₘ, in addition to the control filter coefficient W₁.

### The First Embodiment

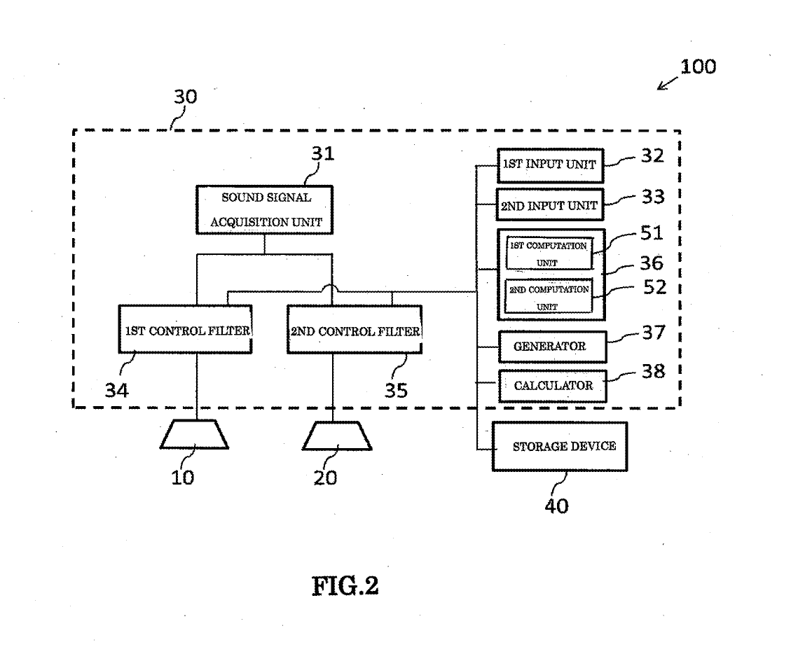

FIG. 2 is a block diagram of a sound control apparatus 100 according to the first embodiment.

The sound control apparatus 100 includes a first speaker (for left) 10, a second speaker (for right) 20, an operation processor (such as a CPU) 30, and a storage device (such as a memory) 40.

In the operation processor 30, by executing filtering processing to the sound signal (monaural signal), a first sound signal to be outputted to the first speaker 10 and a second sound signal to be outputted to the second speaker 20 are calculated. By acquiring the first sound signal from the operation processor 30, the first speaker 10 radiates a sound (first sound) according to the first sound signal. By acquiring the second sound signal from the operation processor 30, the second speaker 20 radiates a sound (second sound) according to the second sound signal. The storage device 40 stores information such as a set of head-related transfer functions used for sound control by the operation processor 30.

The operation processor 30 includes a sound signal acquisition unit 31, a first input unit 32, a second input unit 33, a first control filter 34, a second control filter 35, a decision unit 36, a generator 37, and a calculator 38. Here, these are realized by executing each processing by the operation processor 30, based on program stored in a storage medium (For example, the storage device 40).

The sound signal acquisition unit 31 acquires a sound signal (monaural signal), and supplies it to the first control filter 34 and the second control filter 35. As a method for the sound signal acquisition unit 31 to acquire the sound signal, various variations can be applied. For example, by the terrestrial broadcasting or satellite broadcasting such as a television, an audio device or an audio visual device, a content including the sound signal (For example, a content including the sound signal only, a content including the sound signal with videos or images, a content including another related information therewith) can be acquired. The content may be acquired via a network such as an Internet, an Intranet or a home network. Furthermore, the content may be acquired by reading from a storage medium such as a CD, a DVD, or an internal disk drive. Furthermore, the sound inputted from a microphone may be acquired.

The first input unit 32 acquires a virtual sound source position information (representing a position of the virtual sound source), and supplies it to the decision unit 36 and the generator 37. As a method for the input unit 32 to acquire the virtual sound source position information, for example, the virtual sound source position information inputted by the listener via an input terminal (not shown in FIG. 2) may be acquired. Furthermore, the virtual sound source position information included as relational information in the content (acquired by the sound signal acquisition unit 31) may be acquired.

The second input unit 33 acquires a listening position information (representing positions of a first listening point and a second listening point), and supplies it to the calculator 38. As a method for the second input unit 33 to acquire the listening position information, for example, by measuring the listener's position with a sensor (not shown in FIG. 2) in real time, the listening position information can be acquired based on this measurement result. Furthermore, if the listening position is indicated in advance, the listening position information previously stored in the storage device 40 may be acquired.

The first control filter 34 calculates a first sound signal by convolving the sound signal with the first control filter coefficient corresponding to the first speaker 10. The first control filter 34 supplies the first sound signal to the first speaker 10.

The second control filter 35 calculates a second sound signal by convolving the sound signal with the second control filter coefficient corresponding to the second speaker 20. The second control filter 35 supplies the second sound signal to the second speaker 20.

By using the virtual sound source position information accepted from the first input unit 32, the decision unit 36 decides one speaker nearer (nearest) to the virtual sound source position among the first speaker 10 and the second speaker 20. Hereinafter, a speaker nearest to the virtual sound source position is called a main speaker. For example, at timing whenever new virtual sound source position information is accepted from the first input unit 32, the decision unit 36 decides the main speaker.

The decision unit 36 includes a first computation unit 51 and a second computation unit 52. For example, by using a position information (previously stored in the storage device 40) of each speaker and the virtual sound source position information, the first computation unit 51 calculates a distance between each speaker position and the virtual sound source position. By comparing the calculated distances between each speaker position and the virtual sound source position, the second computation unit 52 decides a speaker located in the shortest distance as the main speaker.

By using the virtual sound source position information accepted from the first input unit 32, the generator 37 generates a target sound pressure ratio for a synthesis sound transmitted (from the first speaker 10 and the second speaker 20) to the first and second listening points to satisfy. Here, the target sound pressure ratio is to be satisfied with a ratio (a complex sound pressure ratio) of a sound pressure at the first listening point to a sound pressure at the second listening point. If a speaker exists at the virtual sound source position, when this speaker radiates a sound according to the sound signal, the generator 37 calculates a ratio of a sound pressure of the sound at the first listening point to a sound pressure of the sound at the second listening point, as the target sound pressure ratio. In order to calculate the target sound pressure ratio, the sound signal, and a set of head-related transfer functions (a second set of head-related transfer functions) from the virtual sound source position to the first and second listening points is used. The second set of head-related transfer functions is stored into the storage device 40.

By using the listening position information accepted from the second input unit 33, the calculator 38 calculates a first control filter coefficient and a second control filter coefficient. Here, as to a synthesis sound of a first sound radiated from the first speaker 10 and a second sound radiated from the second speaker 20, the calculator 38 calculates the first control filter coefficient and the second control filter coefficient so that a ratio (a complex sound pressure ratio) of a sound pressure at the first listening point to a sound pressure at the second listening point is equal to the target sound pressure ratio. In order to calculate them, a head-related transfer function from the first speaker 10 to the first and second listening points, and a head-related transfer function from the second speaker 20 to the first and second listening points are used (these head-related transfer functions are called a first set thereof). For example, according to the equations (1)˜(4), the first control filter coefficient and the second control filter coefficient can be calculated.

In the first embodiment, the calculator 38 calculates a control filter coefficient corresponding to a main speaker (decided by the decision unit 36), as a reference control filter coefficient (For example, the control filter coefficient “W₁=1” having a through characteristic). Furthermore, the calculator 38 calculates a control filter coefficient corresponding to another speaker, based on the reference control filter coefficient.

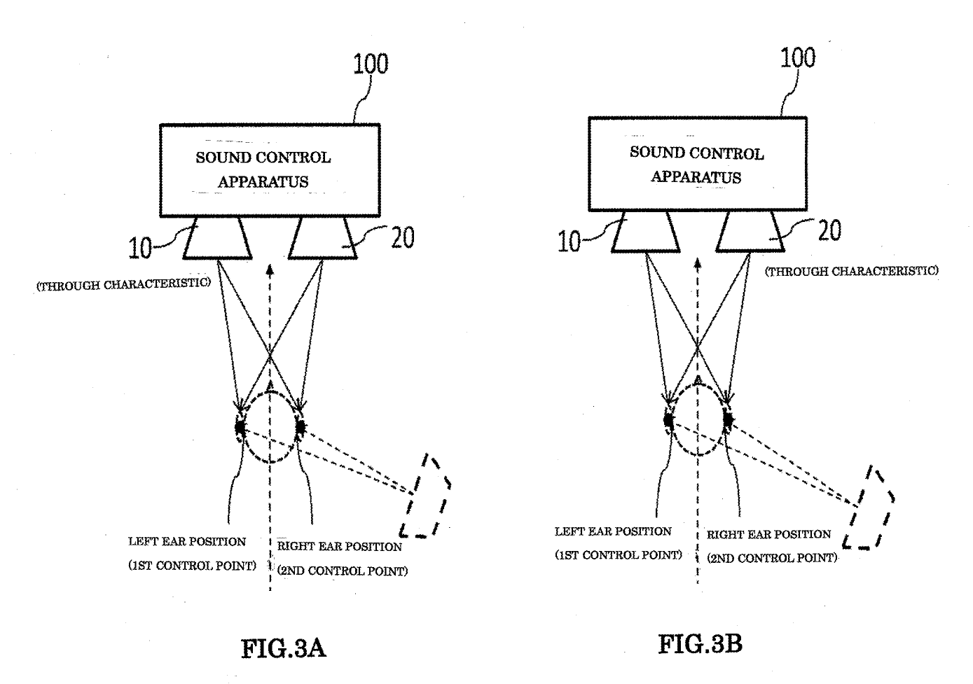

FIGS. 3A and 3B are schematic diagrams showing relationship between the virtual sound source position and each speaker position according to the first embodiment.

Following equation represents a denominator of the control filter coefficient Wₘ.

$${B}_{m}^{( m )} = {\sum }_{i = 1}^{N} {A}_{im}^{( m )} \overline{{A}_{im}^{( m )}} = {\sum }_{i = 1}^{N} \vert {A}_{im}^{( m )} \vert \qquad ( 5 )$$

If a value of the denominator is smaller, a value of the control filter coefficient Wₘ increases in surplus. Then, a portion of frequency components of the sound signal is increased in surplus by this control filter. Furthermore, if power-balance among frequency components of reproduced sound signals is lost, the sound quality is deteriorated.

As shown in FIG. 3A, on the basis of the listener's forward direction (a direction facing to each speaker), a case that the virtual sound source position exists at the right side of the listener is thought about. In this case, a volume of sound arriving at the listener's right ear (second listening point) needs be larger than a volume of sound arriving at the listener's left ear (first listening point).

As shown in FIG. 3A, if the first control filter coefficient corresponding to the first speaker 10 is regarded as a control filter (i.e., “1”) having a through characteristic, a volume of sound radiated from the first speaker 10 is always constant irrespective of the virtual sound source position. In order to increase a volume of sound radiated from the second speaker 20, a value of the second control filter coefficient corresponding to the second speaker 20 is increased. Here, a sound wave having low frequency is easy to be diffracted while a sound wave having high frequency is hard to be diffracted. In comparison with a sound having low frequency, a volume difference of a sound having high frequency between both (right and left) ears is larger. Accordingly, in comparison with low frequency, a value of the control filter coefficient of high frequency is easy to be increased in surplus. Namely, in comparison with a sound having low frequency, a gain of a sound having high frequency is increased. As a result, power-balance among frequency components of sound signals outputted from each speaker is lost, and the sound quality is deteriorated.

On the other hand, as shown in FIG. 3B, if the second control filter coefficient corresponding to the second speaker 20 is regarded as a control filter (i.e., “1”) having a through characteristic, a volume of sound radiated from the second speaker 20 is always constant irrespective of the virtual sound source position. In this case, a volume of sound radiated from the first speaker 10 is smaller than a volume of sound radiated from the second speaker 10. Accordingly, in comparison with the example of FIG. 3A, a value of the first control filter coefficient corresponding to the first speaker 10 is not increased. As a result, in comparison with the example of FIG. 3A, power-balance among frequency components of sound signals outputted from each speaker is not lost, and degradation of the sound quality is suppressed.

In above explanation, the reference control filter coefficient corresponding to the main speaker is the control filter coefficient having the through characteristic. However, it is not always the control filter coefficient having the through characteristic. For example, it may be a control filter coefficient to amplify a volume by multiplying a gain with the sound signal. Furthermore, if the virtual sound source position exists at the left side of the listener, when the decision unit 36 decides the second speaker 20 as the main speaker, the sound quality is relatively deteriorated. Contrary to this, when the decision unit 36 decides the first speaker 10 as the main speaker, degradation of the sound quality is relatively suppressed.

As mentioned-above, in the first embodiment, the calculator 38 calculates the control filter coefficient corresponding to the main speaker nearest to the virtual sound source position, as a control filter coefficient referenced for calculating another control filter coefficient. Accordingly, irrespective of the virtual sound source position, degradation of the sound quality can be suppressed.

In the example of FIG. 2, the first control filter 34 outputs the first sound signal to the first speaker 10 directly, and the second control filter 35 outputs the second sound signal to the second speaker 20 directly.

However, for example, between the first control filter 34 and the first speaker 10, and between the second control filter 35 and the second speaker 20, the sound control apparatus 100 may include an amplifier to adjust a volume. In this case, the first control filter 34 and the second control filter 35 supply each amplified sound signal to the first speaker 10 and the second speaker 20 via the amplifier.

For example, this amplifier adjusts the volume according to information from an input unit such as a switch (not shown in Fig.).

(The First Modification)

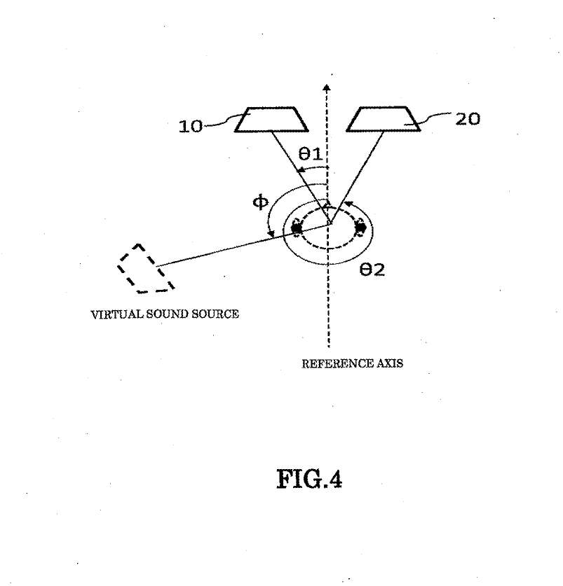

FIG. 4 is a schematic diagram to explain the decision unit 36 according to the first modification.

In the first modification, the decision unit 36 accepts the virtual sound source position information from the first input unit 32, and the listening position information from the second input unit 33. By using position information of each speaker (previously stored in the storage device 40), the virtual sound source position information and the listening position information, the first computation unit 51 sets the listening position as a center, and sets a forward direction (direction facing to speakers) of the listening position to a reference axis having 0°. On the basis of this reference axis, the first computation unit 51 calculates a direction toward a position of each speaker (For example, an angle θ between the reference axis and an axis connected by the listening position and each speaker). Furthermore, on the basis of the reference axis, the first computation unit 51 calculates a direction toward the virtual sound source position (For example, an angle φ between the reference axis and an axis connected by the listening position and the virtual sound source position). By comparing the direction θ toward each speaker with the direction φ toward the virtual sound source position, the second computation unit 52 decides a speaker having direction nearest to the direction of the virtual sound source position, as the main speaker. Here, the direction nearest is a direction θ of which |θ−φ| is minimum.

(The Second Modification)

In the second modification, the decision unit 36 decides a speaker corresponding to the reference control filter coefficient as a main speaker, when a sum of energy of the control filter coefficient corresponding to the first speaker 10 and the control filter coefficient corresponding to the second speaker 20 is minimized.

For example, according to an indication from the decision unit 36, the control filter coefficient corresponding to the first speaker 10 is set to the reference control filter coefficient W₁. According to the equations (1)˜(4), the calculator 38 calculates all control filter coefficients Wₘ(1≦m≦2). Next, according to a following equation (6), the calculator 38 calculates a sum of energy (a first sum of energy) of all control filter coefficients.

Σₘ₌₁^{M}|Wₘ|² (6)

Furthermore, the control filter coefficient corresponding to the second speaker 20 is set to the reference control filter coefficient W₁. The calculator 38 calculates all control filter coefficients Wₘ(1≦m≦2). According to the equation (6), the calculator 38 calculates a sum of energy (a second sum of energy) of all control filter coefficients.

By comparing the first sum with the second sum (calculated by the calculator 38), the decision unit 36 decides a speaker corresponding to the reference control filter coefficient from which smaller one (the first sum or the second sum) is calculated, as the main speaker.

In the second modification, the decision unit 36 and the calculator 38 are explained as different functions. However, they can be merged as the same function.

(The Third Modification)

In the third modification, the decision unit 36 decides a speaker corresponding to the reference control filter coefficient as a main speaker, when a reciprocal of sum of energy of a denominator term of the control filter coefficient corresponding to the first speaker 10 and a denominator term of the control filter coefficient corresponding to the second speaker 20 is minimized.

For example, according to an indication from the decision unit 36, the control filter coefficient corresponding to the first speaker 10 is set to the reference control filter coefficient W₁. According to the equations (2)˜(4), the calculator 38 calculates a denominator term Bₘ(1≦m≦2) of all control filter coefficients. Next, according to a following equation (7), the calculator 38 calculates a reciprocal of sum of energy (a first sum of energy) of the denominator term of all control filter coefficients.

1/Σₘ₌₁^{M}|Bₘ^{(m)}|² (7)

Furthermore, the control filter coefficient corresponding to the second speaker 20 is set to the reference control filter coefficient W₁. The calculator 38 calculates a denominator term Bₘ(1≦m≦2) of all control filter coefficients. According to the equation (7), the calculator 38 calculates a reciprocal of sum of energy (a second sum of energy) of the denominator term of all control filter coefficients.

By comparing the first sum with the second sum (calculated by the calculator 38), the decision unit 36 decides a speaker corresponding to the reference control filter coefficient from which smaller one (the first sum or the second sum) is calculated, as the main speaker.

In the third modification, the decision unit 36 and the calculator 38 are explained as different functions. However, they can be merged as the same function.

### The Second Embodiment

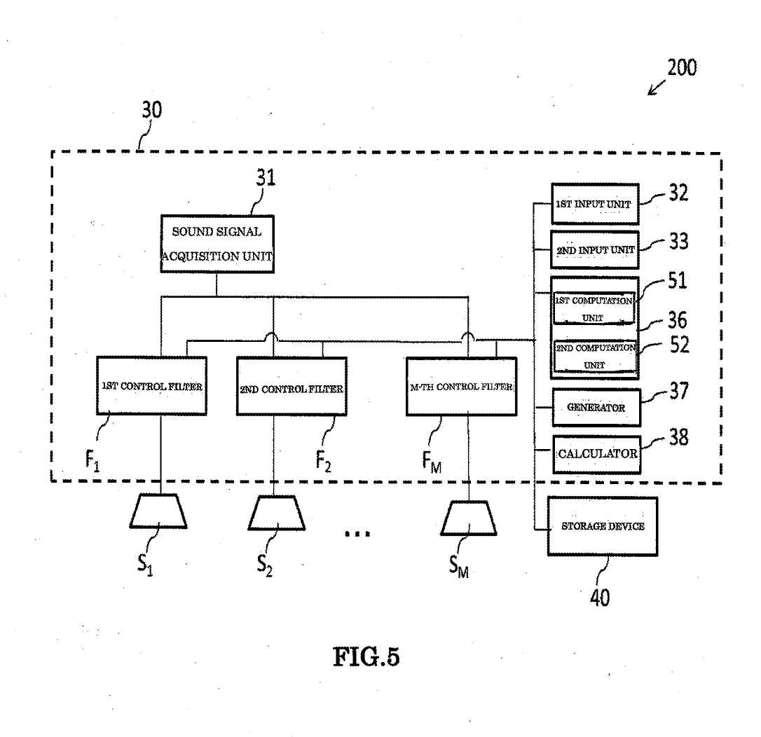

FIG. 5 is a block diagram of a sound control apparatus 200 according to the second embodiment. The sound control apparatus 200 includes speakers S₁˜S_{M}(M≧3) and control filters F₁˜F_{M}. These components are different from the sound control apparatus 100.

In the second embodiment, by using the virtual sound source position information accepted from the first input unit 32, the decision unit 36 decides a speaker (main speaker) nearest to the virtual sound source position and a speaker farer (farthest) therefrom among speakers S₁˜S_{M}. Hereinafter, the speaker farthest from the virtual sound source position is called a sub speaker. By using position information of each speaker (previously stored in the storage device 40) and the virtual sound source information, the first computation unit 51 calculates a distance between the virtual sound source position and a position of each speaker. By comparing the distance between the virtual sound source position and the position of each speaker, the second computation unit 52 decides a speaker having the longest distance as the sub speaker.

By using the listening position information accepted from the second input unit 33, the calculator 38 calculates control filter coefficients of from the first to the M-th. Here, as to each sound radiated from the speakers S₁˜S_{M}, the calculator 38 calculates control filter coefficients of from the first to the M-th, so that a ratio (a complex sound pressure ratio) of a sound pressure at the first listening point to a sound pressure at the second listening point is equal to the target sound pressure ratio. In order to calculate them, sets of head-related transfer functions from the speakers S₁˜S_{M} to the first and second listening points is used. For example, according to the equations (1)˜(4), each control filter coefficient Wₘ can be calculated.

In the second embodiment, the calculator 38 calculates a control filter coefficient corresponding to the main speaker (decided by the decision unit 36), as a reference control filter coefficient (For example, the control filter coefficient “W₁=1” having a through characteristic). Furthermore, the calculator 38 calculates a control filter coefficient corresponding to each of other speakers (speakers S₁˜S_{M} excluding the main speaker), based on the reference control filter coefficient W₁. Specifically, a control filter coefficient W_{M} corresponding to the sub speaker is calculated based on all the other control filter coefficients W₁˜W_{M-1}.

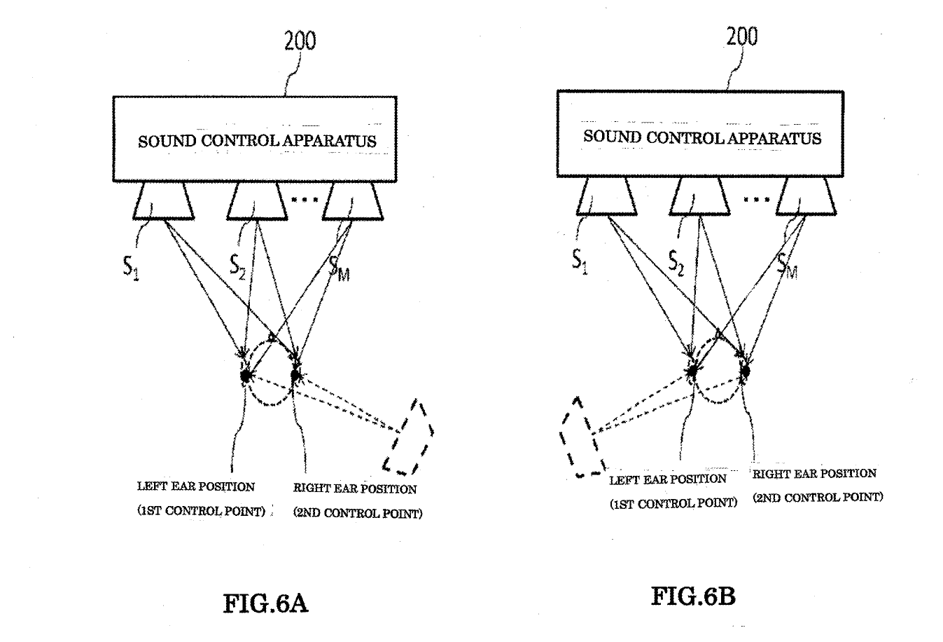

FIGS. 6A and 6B are schematic diagrams showing relationship between the virtual sound source position and each speaker position according to the second embodiment.

A denominator of the control filter coefficient W_{M} corresponding to the M-th speaker (a speaker corresponding to the control filter coefficient W_{M} calculated last by the equation (1)) is calculated by a following equation (8).

$${B}_{M}^{( M )} = {\sum }_{i = 1}^{N} {\vert {A}_{iM}^{( M )} \vert}^{2} = {\sum }_{i = 1}^{N} {\vert {C}_{{L}_{i} M} \cdot {d}_{{R}_{i}} - {C}_{{R}_{i} M} \cdot {d}_{{L}_{i}} \vert}^{2} \qquad ( 8 )$$

For example, as shown in FIGS. 6A and 6B, the M-th speaker is located at the right side of the listening position. Here, a volume of sound come from the M-th speaker arriving at the left ear (the far side from the M-th speaker) is smaller (i.e., |C_{L,M}|≈0).

Here, on the basis of the forward direction of the listener (a direction facing to speakers), if the virtual sound source position exists at the right side of the listener (FIG. 6A), a volume of sound come from the virtual sound source arriving at the left ear (the far side from the virtual sound source) is smaller (i.e., |d_{Li}|≈0). In this case, as a whole, above-mentioned equation represents “B_{M}^{(M)}≈0”. As a result, a value of the control filter coefficient W_{M} is increased in surplus.

On the other hand, if the virtual sound source position exists at the left side of the listener (FIG. 6B), a volume of sound come from the virtual sound source arriving at the left ear is larger. Namely, a value of “d_{Li}” is large. Accordingly, a value of “B_{M}^{(M)}” is also large, and a value of the control filter coefficient W_{M} is not increased in surplus.

From the above, as to a sound signal outputted from the M-th speaker located at the right side of the listening position, if the virtual sound source position exists at the right side of the listening position, the sound quality is deteriorated. On the other hand, if the virtual sound source position exists at the left side of the listening position, the sound quality is not deteriorated. Namely, by setting the sub speaker farthest from the virtual sound source position to the M-th speaker, degradation of the sound quality can be suppressed.

In above-explanation, the case that the M-th speaker is located at the right side of the listening position is described as the example. However, if the M-th speaker is located at the left side of the listening position, a direction of the virtual sound source position along which the sound quality is deteriorated is mirrored (left and right reversed). Namely, if the M-th speaker and the virtual sound source exist at the same side among left and right sides, the sound quality is deteriorated. If the M-th speaker and the virtual sound source exist at different sides among left and right sides, the sound quality is not deteriorated.

As mentioned-above, in the second embodiment, the calculator 38 calculates the control filter coefficient corresponding to the main speaker nearest to the virtual sound source position, as a control filter coefficient referenced for calculating other control filter coefficients. In addition to this, the calculator 38 calculates the control filter coefficient corresponding to the sub speaker farthest from the virtual sound source position, based on all of other control filter coefficients. Accordingly, irrespective of the virtual sound source position, degradation of the sound quality can be further suppressed.

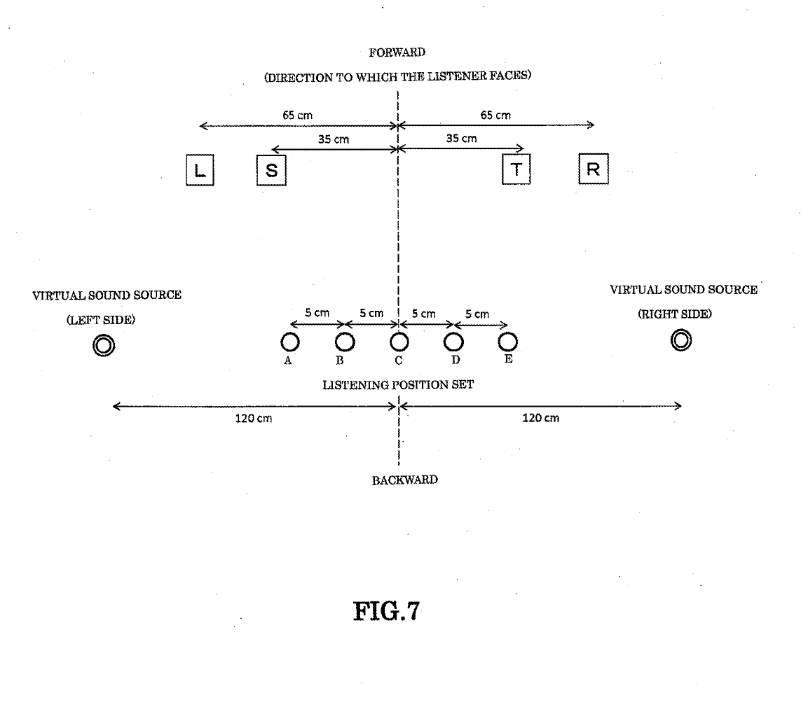

FIG. 7 is a schematic diagram showing relationship among each virtual sound source position and each speaker position according to the second embodiment. As shown in FIG. 7, the sound control apparatus equips four speakers L, S, T, R in front of a listening position set A, B, C, D, E. Here, a distance between adjacent two listening positions in the listening position set is 5 cm. On the basis of a center listening position C, a speaker L is located at the left side 65 cm, a speaker S is located at the left side 35 cm, a speaker T is located at the right side 35 cm, and a speaker R is located at the right side 65 cm. Under this condition, sound control according to the second embodiment is performed by using a predetermined monaural signal.

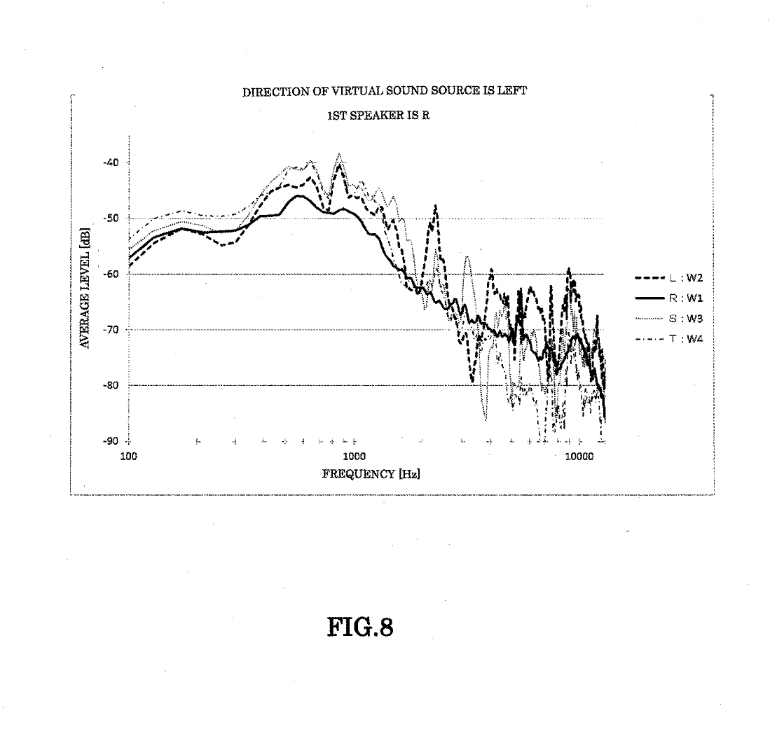

FIG. 8 shows frequency characteristics of an output level of a sound signal outputted from each speaker, if the virtual sound source position is located at the left side of listening positions and if a speaker R is the main speaker. As shown in FIG. 8, a frequency characteristic of the speaker R represented by a thick solid line is a through output. Accordingly, this frequency characteristic is equal to an original frequency characteristic of the sound signal. Output levels of other three speakers are higher than an output level of the speaker R in many frequency bands centrally around a high frequency area. In comparison with the original sound signal, the output levels are increased in surplus. Namely, the sound quality of these sound signals is deteriorated.

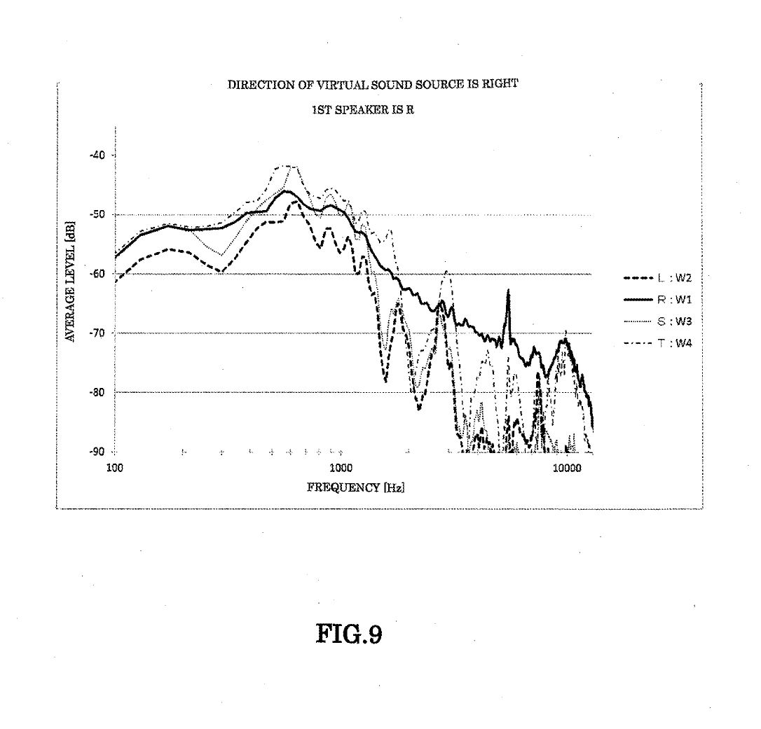

FIG. 9 shows frequency characteristics of an output level of a sound signal outputted from each speaker, if the virtual sound source position is located at the right side of listening positions and if the speaker R is the main speaker. As shown in FIG. 9, output levels of other three speakers (except for the speaker R) are lower than an output level of the speaker R in frequency bands (excluding slight frequency bands), especially, a high frequency area easy to affect the sound quality. Accordingly, degradation of the sound quality of these sound signals is suppressed.

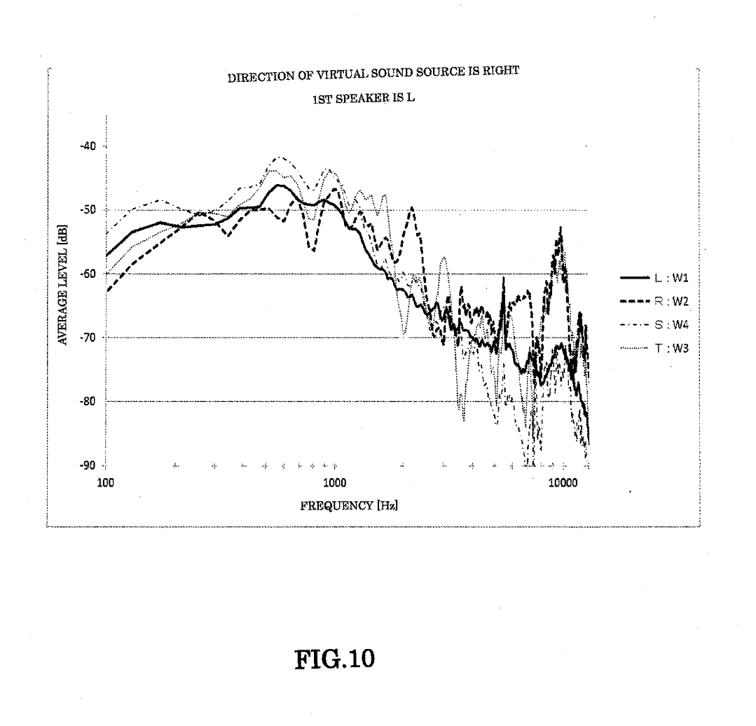

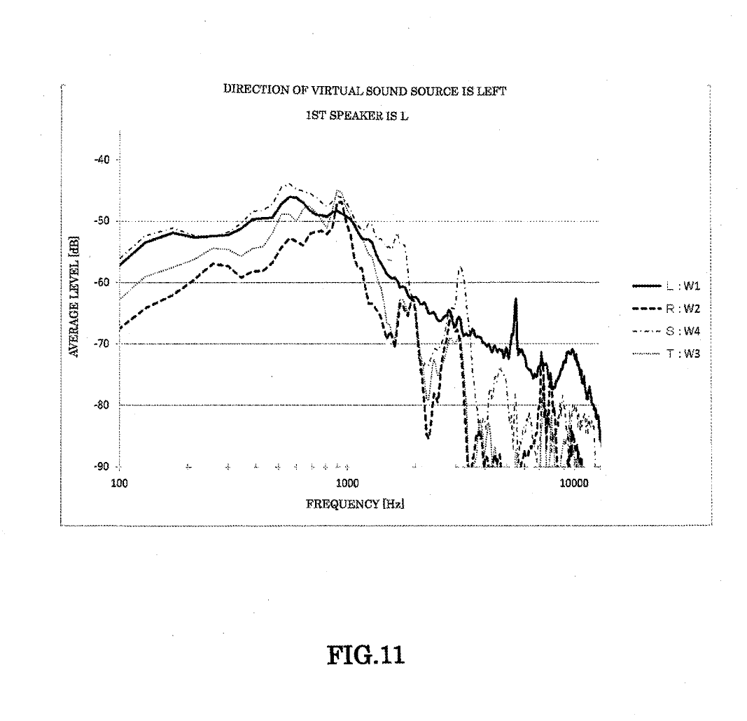

In the same way, if a speaker L is the main speaker and if the virtual sound source position exists at the right side, as shown in FIG. 10, the sound quality of three speakers excluding the speaker L (having a through output) is deteriorated. On the other hand, if the virtual sound source position exists at the left side, as shown in FIG. 11, degradation of the sound quality of the three speakers is suppressed.

Namely, from the above, by switching the main speaker (having a through output) to a speaker nearest to the virtual sound source position, degradation of the sound quality is suppressed.

As mentioned-above, in the sound control apparatus according to at least one embodiment, irrespective of the virtual sound source position, degradation of the sound quality is suppressed.

While certain embodiments have been described, these embodiments have been presented by way of examples only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A sound control apparatus for supplying a first sound signal to a first speaker and a second sound signal to a second speaker, the first speaker radiating a first sound toward a first listening point and a second listening point based on the first sound signal, the second speaker radiating a second sound toward the first listening point and the second listening point based on the second sound signal, the apparatus comprising:
a first control filter that generates the first sound signal by convolving a sound signal with a first control filter coefficient;
a second control filter that generates the second sound signal by convolving the sound signal with a second control filter coefficient;
an input unit that inputs a position information of a virtual sound source;
a decision unit that decides a nearer speaker to the virtual sound source among the first speaker and the second speaker, based on the position information; and
a calculator that calculates the first control filter coefficient and the second control filter coefficient so that a ratio of a first synthesis sound pressure of the first sound and the second sound at the first listening point to a second synthesis sound pressure of the first sound and the second sound at the second listening point is equal to a target sound pressure ratio,
wherein, among the first control filter coefficient and the second control filter coefficient, one control filter coefficient corresponding to the nearer speaker is calculated, and the other control filter coefficient corresponding to another speaker is calculated based on the one control filter coefficient.

2. The apparatus according to claim 1, further comprising:
a generator that generates a ratio of a sound pressure at the first listening point to a sound pressure at the second listening point as the target sound pressure ratio, when the virtual sound source radiates a sound based on the sound signal;
wherein the calculator calculates the first control filter coefficient and the second control filter coefficient, based on the target sound pressure ratio generated by the generator.

3. The apparatus according to claim 1, wherein
the first listening point is one of a plurality of first listening points,
the second listening point is one of a plurality of second listening points, and
the calculator calculates the first control filter coefficient and the second control filter coefficient so that a spatial average of the ratio at the plurality of first listening points and the plurality of second listening points is equal to a spatial average of the target sound pressure ratio at the plurality of first listening points and the plurality of second listening points.

4. The apparatus according to claim 1, wherein
the decision unit comprises
a first computation unit that calculates a first distance between the virtual sound source and the first speaker and a second distance between the virtual sound source and the second speaker, based on the position information, and
a second computation unit that compares the first distance with the second distance.

5. The apparatus according to claim 1, further comprising:
a second input unit that inputs a listening position information representing a listening position;
wherein the decision unit comprises
a first computation unit that calculates a first direction from the listening position to each speaker and a second direction from the listening position to the virtual sound source, based on the position information and the listening position information, and
a second computation unit that compares the first direction of each speaker with the second direction.

6. The apparatus according to claim 1, wherein
the calculator calculates a first sum of energy of the first control filter coefficient and the second control filter coefficient if one of the first and second control filter coefficients corresponding to the first speaker is set as a reference, and calculates a second sum of energy of the first control filter coefficient and the second control filter coefficient if the other of the first and second control filter coefficients corresponding to the second speaker is set as the reference, based on an indication from the decision unit, and
the decision unit decides one of the first and second speakers corresponding to the reference at which a smaller one of the first sum and the second sum is calculated, as the nearer speaker to the virtual sound source.

7. The apparatus according to claim 6, wherein
the calculator calculates a reciprocal of sum of energy of a denominator term of the first control filter coefficient and a denominator term of the second control filter coefficient if the one control filter coefficient corresponding to the first speaker is the reference, as the first sum, and calculates a reciprocal of sum of energy of a denominator term of the first control filter coefficient and a denominator term of the second control filter coefficient if the other control filter coefficient corresponding to the second speaker is the reference, as the second sum.

8. The apparatus according to claim 1, wherein
the calculator calculates the first control filter coefficient and the second control filter coefficient, based on a first set of head-related transfer functions from the first speaker and the second speaker to the first listening point and the second listening point.

9. The apparatus according to claim 2, wherein
the generator generates the target sound pressure ratio, based on a second set of head-related transfer functions from the virtual sound source to the first listening point and the second listening point.

10. The apparatus according to claim 1, wherein
the apparatus further supplies a third sound signal to a third speaker, the third speaker radiating a third sound toward the first listening point and the second listening point based on the third sound signal,
the apparatus further comprises
a third control filter that generates the third sound signal by convolving the sound signal with a third control filter coefficient;
wherein
the decision unit decides the nearest speaker to the virtual sound source among the first speaker, the second speaker and the third speaker, and the farthest speaker from the virtual sound source among the first speaker, the second speaker and the third speaker, and
the calculator calculates the first control filter coefficient, the second control filter coefficient and the third control filter coefficient so that a ratio of the first synthesis sound pressure further including the third sound at the first listening point to the second synthesis sound pressure further including the third sound at the second listening point is equal to the target sound pressure ratio,
wherein, among the first control filter coefficient, the second control filter coefficient and the third control filter coefficient, one control filter coefficient corresponding to the nearest speaker is calculated, and another control filter coefficient corresponding to the farthest speaker is calculated based on the first, second and third control filter coefficients excluding the another control filter coefficient.
